(19) United States
(12) Patent Application Publication
(10) Pub. No.: US 2007/0281189 A1
(43) Pub. Date: Dec. 6, 2007

(54) Fuel cell apparatus

(76) Inventors: Daisuke Watanabe, Ome-shi (JP); Akihiro Ozeki, Chiryu-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/805,288

(22) Filed: May 22, 2007

(30) Foreign Application Priority Data
May 31, 2006 (JP) 2006-152167

(51) Int. Cl. H01M 8/04

(52) U.S. Cl. 429/14

(57) ABSTRACT

According to one embodiment, a fuel cell apparatus includes a power generator portion which generates electricity through a chemical reaction, a fuel tank containing fuel and having a fuel supply port which supplies fuel and an air inlet which lets air into the fuel tank, and a circulation system which supplies fuel and air to the power generator portion. The circulation system has a fuel passage which circulates the fuel supplied from the fuel supply port of the fuel tank through the power generator portion, and an air passage which circulates air through the power generator portion. The air inlet of the fuel tank is connected to the circulation system.

### CROSS-REFERENCE TO RELATED APPLICATIONS

This application is based upon and claims the benefit of priority from Japanese Patent Application No. 2006-152167, filed May 31, 2006, the entire contents of which are incorporated herein by reference.

### BACKGROUND

1. Field

One embodiment of the present invention relates to a fuel cell apparatus used as a power source for electronic devices and the like.

2. Description of the Related Art

A secondary battery such as a lithium ion battery is now mainly used as a power source in use for electronic devices such as a portable, notebook type personal computer (to be referred to be a notebook PC) and a mobile device. Recent high-performance electronic devices bring about increase of power consumption and elongation of the device use time. In this circumstance, a micro fuel cell is expected as a new type high-power source which does not need to be charged. There are many types of fuel cells. Of those fuel cells, particularly the direct methanol fuel cell (DMFC) using methanol solution as liquid fuel has attracted attention as a power source for electronic devices since the fuel handling is easier and the system construction is simpler than the fuel cells using hydrogen as fuel.

Normally, the DMFC includes a fuel tank containing methanol of high concentration, a mixing tank for diluting the methanol of the fuel tank with water, a liquid feeding pump for press-feeding the diluted methanol to a power generator portion, and an air feeding pump for feeding air to the power generator portion. The power generator portion includes a cell stack in which a plurality of cells each having an anode and a cathode are stacked. The power generator portion generates electricity through a chemical reaction when the diluted methanol is fed to the anode of the cell stack and air is fed to the cathode. The reaction by-products as the result of electricity generation are carbonic acid produced at the anode and water at the cathode. The water which is the reaction by-product is exhausted in the form of steam. The exhaust from the cathode of the power generator portion is fed to a cooling part through a cathode passage, and it is condensed into water. The water is collected and used for diluting the methanol.

Some types of fuel filling methods have been employed for filling the fuel into the fuel tank for supplying fuel. In many fuel filling methods other than the pressurized gas filling method, when the fuel in the fuel tank is consumed for electric power generation, the fuel tank must be filled with air or water of which the volume is equal to a volume of the consumed fuel. The fuel tank employing the fuel filling method of the air-replenishing type normally includes an air inlet which is opened to the air. Jpn. Pat. Appln. KOKAI Publication No. 2005-11635 discloses another fuel tank in which water generated at the cathode or the water and air are collected in the fuel tank, and fuel is supplied by shifting a movable partitioning portion that is provided in the fuel tank.

The structure in which the air inlet of the fuel tank is opened to the air involves the following problems.

Firstly, the fuel liquid for the fuel cell easily permeates to resin material and volatilizes at room temperature. Accordingly, there is a possibility that part of the liquid fuel volatilizes in the fuel tank and dissipates through the air inlet to outside.

Secondly, in the case where air taken into the fuel tank from the atmosphere is contaminated, impurity contained in the air is mixed into the liquid fuel and the impurity-contained liquid fuel is supplied to the fuel cell system body. Accordingly, the passage will be possibly clogged with the impurity. As a result, the impurity, e.g., ion, is supplied to the power generation portion of the cell and the output power of the fuel cell lowers.

Thirdly, when the pressure in the fuel tank becomes high by temperature rise, for example, a check valve provided at the air inlet may be broken, so that the fuel reversely flows and spouts out. Another possibility is that the volatilized fuel gas is discharged to outside through the check valve, in addition to the spout of the liquid fuel.

In the fuel tank of the type in which the water generated at the cathode is collected, the reduction volume of the fuel is sometimes not equal to the volume of the water generated at the cathode. When the volume of the collected water is smaller than the reduction volume of the fuel, it is difficult to secure a stable fuel supply from the fuel tank. When the volume of the collected water is larger than the fuel reduction volume, an excessive volume of fuel will possibly be supplied from the fuel tank.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a portable computer with a fuel cell apparatus according to a first embodiment of the present invention, and a fuel tank;

FIG. 2 is an exemplary perspective view showing the portable computer loaded with the fuel tank;

FIG. 3 is an exemplary block diagram mainly showing a configuration of a circulation system in the fuel cell apparatus;

FIG. 4 is an exemplary cross sectional view schematically showing a power generator portion in the fuel cell apparatus;

FIG. 5 is an exemplary model diagram showing a cell structure of the power generator portion;

FIG. 6 is an exemplary view showing a state that the fuel tank is going to be loaded into a tank receiving slot of the fuel cell apparatus;

FIG. 7 is an exemplary view showing the fuel tank loaded into the tank receiving slot and a locking mechanism;

FIG. 8 is an exemplary enlarged cross sectional view showing a connecting portion of the fuel tank and circulation system;

FIG. 9 is an exemplary bock diagram mainly showing a configuration of a circulation system in a fuel cell apparatus according to a second embodiment of the invention;

FIG. 10 is an exemplary bock diagram mainly showing a configuration of a circulation system in a fuel cell apparatus according to a third embodiment of the invention;

FIG. 11 is an exemplary bock diagram mainly showing a piping structure and a valve in a circulation system in a fuel cell apparatus according to a fourth embodiment of the invention;

FIG. 12 is an exemplary view showing a fuel tank and a locking mechanism in a modification example of the invention; and

FIG. 13 is an exemplary view showing the fuel tank and the locking mechanism in the modification.

### DETAILED DESCRIPTION

Various embodiments according to the invention will be described hereinafter with reference to the accompanying drawings. In general, according to an embodiment of the invention, a fuel cell apparatus comprises: a power generator portion which generates electricity through a chemical reaction; a fuel tank containing fuel and having a fuel supply port which supplies fuel and an air inlet which lets air into the fuel tank; and a circulation system which supplies fuel and air to the power generator portion, the circulation system having a fuel passage which circulates the fuel supplied from the fuel supply port of the fuel tank through the power generator portion, and an air passage which circulates air through the power generator portion, the air inlet of the fuel tank being connected to the circulation system.

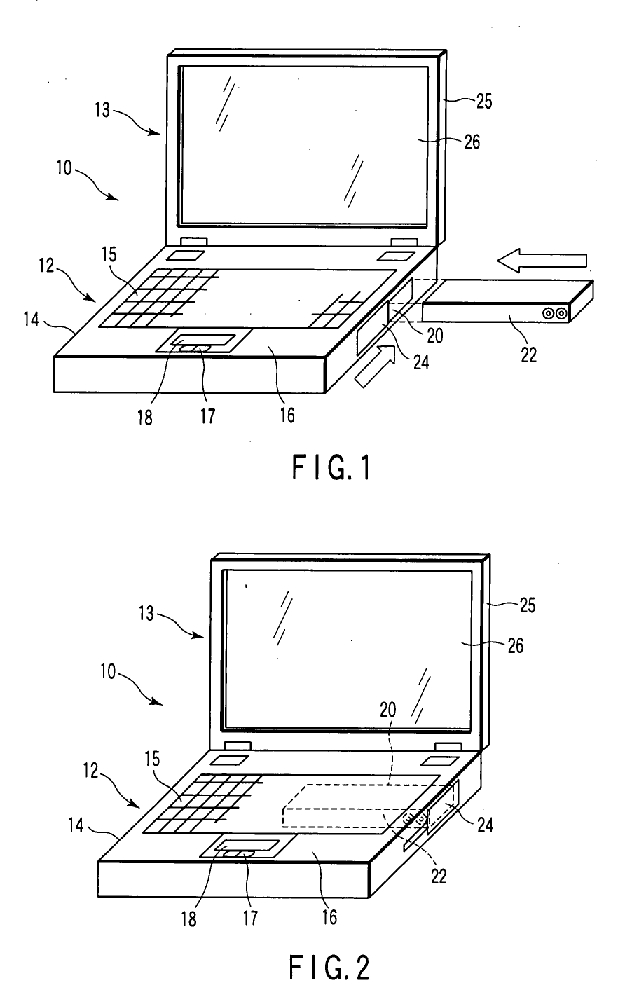

FIGS. 1 and 2 show a portable computer as one form of the information processing apparatus. As shown in FIGS. 1 and 2, the portable computer 10 generally includes an apparatus body 12 and a display unit 13. The apparatus body 12 includes a case 14 made of synthetic resin, for example, and shaped to be a flat box. Input means, which takes the form of a keyboard 15, is arranged at the central portion of the upper surface of the case 14. The front end portion of the upper surface of the case 14 forms a palm rest 16, and a touch pad 18 and a click button 17 are disposed on the central portion of the palm rest.

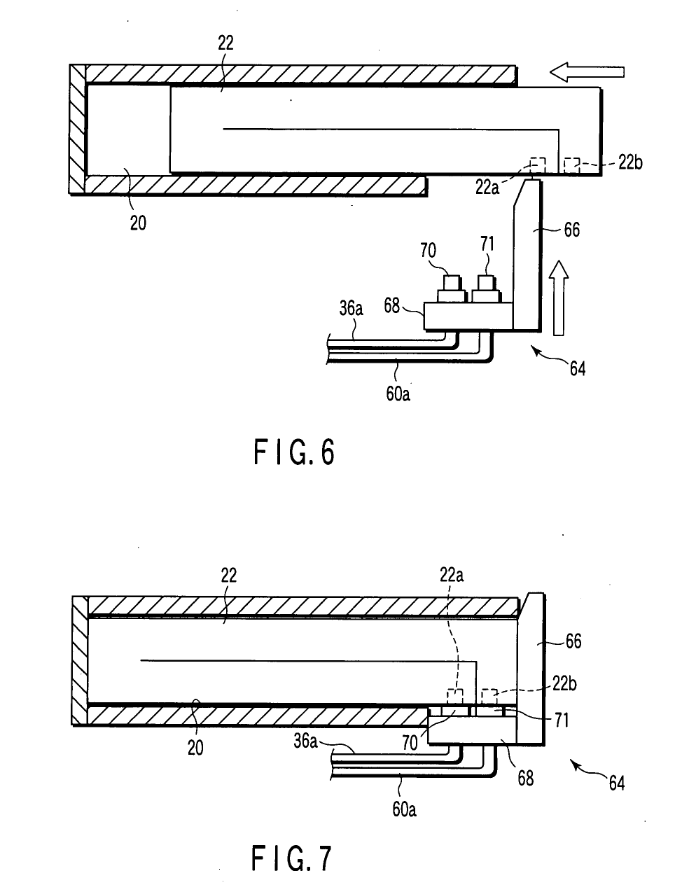

The case 14 contains a fuel cell apparatus to be described later, a drive unit and electronic components. A tank receiving slot 20 is formed in the case 14. The tank receiving slot 20 is opened in one side surface of the case 14. A fuel tank 22, which forms a part of the fuel cell apparatus, is detachably loaded into the tank receiving slot 20. A locking mechanism 64 (see FIGS. 6 and 7), which is provided in the side surface of the case 14, opens and closes the opening of the tank receiving slot 20 and locks the fuel tank 22 at a predetermined position in the tank receiving slot.

As shown in FIGS. 1 and 2, the display unit 13 includes a flat rectangular housing 25 and a liquid crystal display (LCD) panel 26 contained in the housing. The housing 25 is rotatably supported on the rear end of the case 14 with the aid of a hinge. With such a construction, the display unit 13 may be turned between a close position to which it is turned down to cover the keyboard 15 and an opening position to which it is raised at the rear part of the keyboard 15.

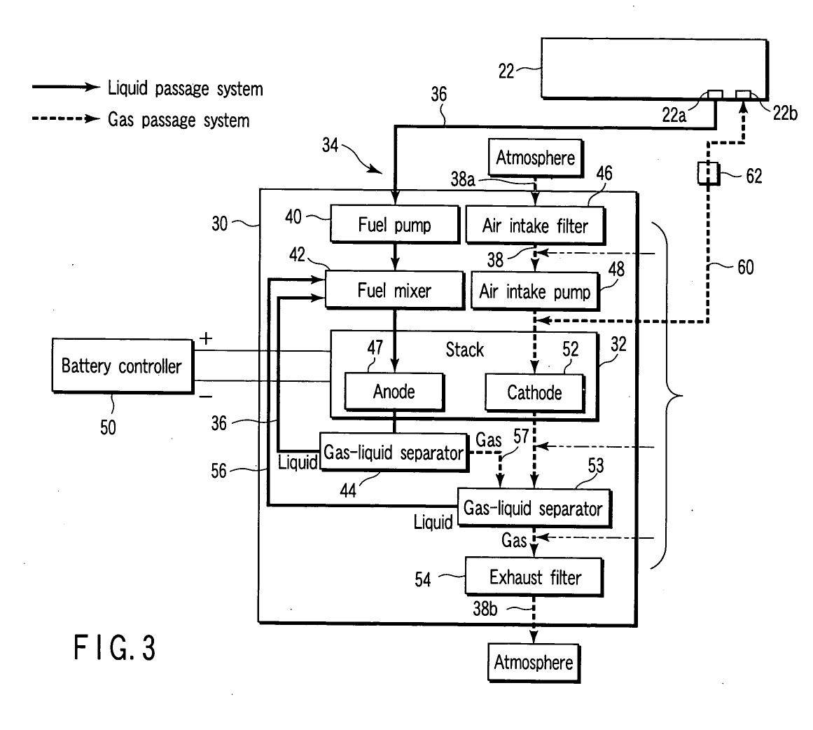

FIG. 3 shows a fuel cell apparatus 30 arranged in the case 14 of the portable computer 10. The fuel cell apparatus 30 is constructed as a DMFC (direct methanol fuel cell) using methanol as liquid fuel. As shown in FIG. 3, the portable computer 10 includes a cell stack 32 forming a power generator portion, the fuel tank 22, and a circulation system 34 for supplying fuel and air to the power generator portion.

The fuel tank 22 is shaped to be a hermetically closed narrow box analogous in shape to the tank receiving slot 20 to be described later. The fuel tank 22 takes the form of a fuel cartridge, which is detachably attached to the fuel cell apparatus 30. The fuel tank 22 contains high concentration methanol as liquid fuel. When the fuel is used up, the fuel tank 22 may be replaced with another one in a simple manner. The fuel tank 22 includes a fuel supply port 22a for supplying fuel and an air inlet 22b for letting air into the fuel tank. The fuel supply port 22a and the air inlet 22b are formed in the side surface of the fuel tank 22, for example. When the fuel cell apparatus is in operation, the fuel tank 22 takes in through the air inlet 22b a volume of air, which is equal to a volume of fuel discharged through the fuel supply port 22a.

The circulation system 34 includes a fuel passage (liquid passage system) 36 for circulating fuel supplied from the fuel supply port 22a of the fuel tank 20 through the cell stack 32, an air passage (gas passage system) 38 for circulating gas containing air through the cell stack 32, and a plurality of auxiliary devices provided in the fuel passage and the air passage. The fuel passage 36 and the air passage 38 are defined with piping or the like.

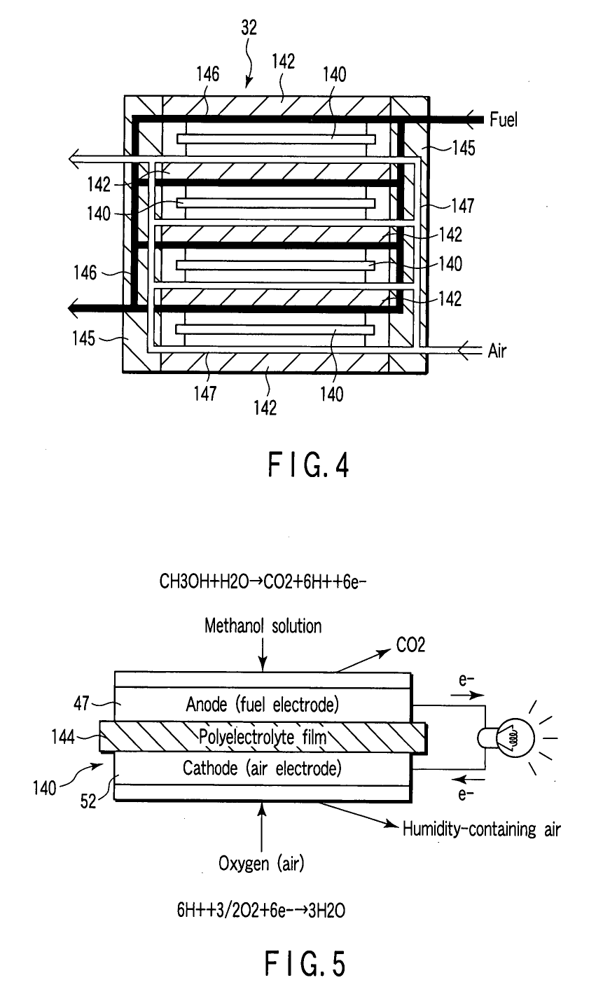

FIG. 4 shows a stack structure of the cell stack 32, and FIG. 5 illustrates a power generation reaction of each cell in a model form. As shown in FIGS. 4 and 5, the cell stack 32 as a cell stack includes a stack body formed such that a plurality (e.g., four) of unit cells 140 and five rectangular separators 142 are alternatively stacked one on another, and a frame 145 supporting the stack body. Each of the unit cells 140 contains a membrane electrode assembly (MEA), which is made up of a cathode 52 and an anode 47, which are each rectangular and formed with a catalyst layer and a carbon paper, and a polyelectrolyte film 144, rectangular in shape, which is sandwiched between the cathode and the anode. The polyelectrolyte film 144 is larger in area than the anode 47 and the cathode 52.

Three of those separators 142 are each sandwiched between the two adjacent unit cells 140, and the remaining two separators are layered on both ends of the stack as viewed in the stacking direction. A fuel passage 146 for supplying fuel to the anode 47 of each unit cell 140 and an air passage 147 for supplying air to the cathode 52 of each unit cell are formed in the separators 142 and the frame 145.

As shown in FIG. 5, the supplied fuel and air chemically react with each other in the polyelectrolyte film 144 located between the anode 47 and the cathode 52 to generate electricity between these electrodes. The electric power generated is fed from the cell stack 32 to the portable computer 10 through a battery controller 50.

As shown in FIG. 3, the auxiliary devices provided in the fuel passage 36 are a fuel pump 40 pipe-coupled to the fuel supply port 22a of the fuel tank 22, a fuel mixer 42 connected by piping to the output portion of the fuel pump 40, and a liquid feeding pump (not shown) connected to the output portion of the fuel mixer 42. The output portion of the liquid feeding pump is connected to the anode (fuel electrode) of the cell stack 32 through the fuel passage 36.

The output portion of the anode 47 of the cell stack 32 is connected to the input portion of the fuel mixer 42 through the fuel passage 36 and a gas-liquid separator 44. Fluids discharged from the anode of the cell stack 32, i.e., non-reacted methanol aqueous solution and generated carbon dioxide not used for chemical reaction, are separated from each other by the gas-liquid separator 44. The separated methanol aqueous solution is fed back to the fuel mixer 42 through the fuel passage 36, and the carbon dioxide is fed to another gas-liquid separator 53 through a gas passage 57 to be described later.

An upstream end 38a and a downstream end 38b of the air passage 38 communicate with the air. The auxiliary devices provided in the air passage 38 are an air intake filter 46 which is located upstream of the cell stack 32 and near the upstream end of the air passage 38, an air suction pump 48 connected to the air passage between the cell stack 32 and the air intake filter, an exhaust filter 54 which is located downstream of the cell stack 32 and near the downstream end of the air passage 38, and a gas-liquid separator 53 provided in the air passage between the cell stack 32 and the exhaust filter.

The air intake filter 46 catches and removes dust, impurities, etc., contained in the air sucked into the air passage 38. The exhaust filter 54 makes the by-products, which are contained in the air exhausted from the air passage 38 to outside, harmless and catches fuel gas and the like contained in the exhausting air.

The gas-liquid separator 53 is connected to the fuel mixer 42 through a fluid passage 56. The gas-liquid separator 53 is connected to the gas-liquid separator 44 through the gas passage 57.

The air inlet 22b of the fuel tank 22 is connected to the circulation system 34 by way of a gas passage 60 defined by piping. In the embodiment, the air inlet 22b is connected to the air passage 38 between the air intake filter 46 and the exhaust filter 54, and specifically it is connected to the air passage 38 between the downstream side of the cell stack 32 and the air suction pump 48. A valve 62, such as a check valve, for checking the reverse gas flow from the air inlet 22b of the fuel tank 22 to the circulation system 34, is provided in the gas passage 60. As indicated by two-dot dashed lines, the air inlet 22b may be connected to the air passage 38 between the air intake filter 46 and the air suction pump 48, between the downstream side of the cell stack 32 and the gas-liquid separator 53, or between the gas-liquid separator 53 and the exhaust filter 54.

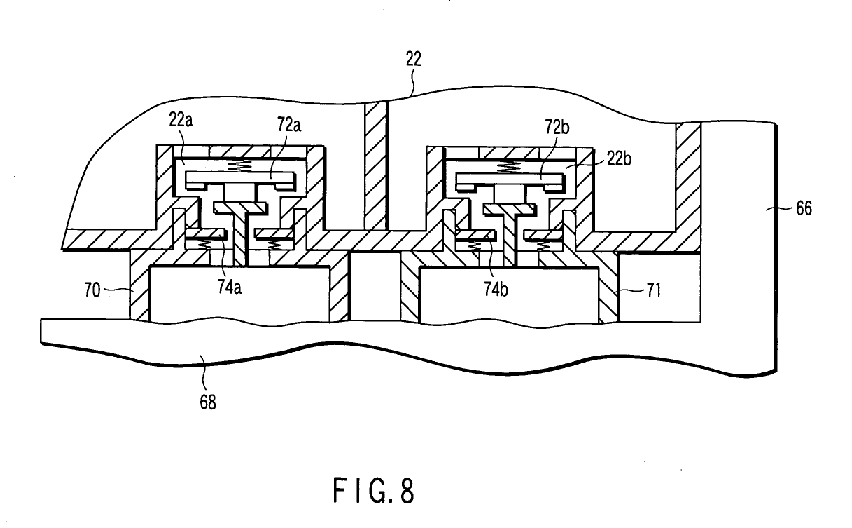

FIG. 6 is a view showing a state that the fuel tank 22 is going to be inserted into the tank receiving slot 20 of the portable computer. FIG. 7 is a view showing the fuel tank 22 inserted into and locked at a predetermined position in the tank receiving slot. FIG. 8 is an enlarged cross sectional view showing a connecting portion of the fuel tank 22 and the circulation system 34 of the fuel cell apparatus 30.

As shown in FIGS. 1, 2, 6 and 7, the fuel tank 22 takes the form of a replaceable fuel cartridge. The fuel tank 22 is loaded into the tank receiving slot and taken out of the slot, through the opening of the tank receiving slot 20.

The fuel cell apparatus 30 is provided with the locking mechanism 64 for locking the fuel tank 22 having been loaded into and set at a predetermined position in the tank receiving slot 20, i.e., a position connected to the circulation system 34, at the predetermined position. The locking mechanism 64 includes a plate-like cover member 66, which is provided on the side surface of the case 14 of the portable computer 10, and an engaging portion 68 extended from the cover member. The cover member 66 is mounted on the side surface of the case 14 such that it is movable between an unlocking position where the opening of the tank receiving slot 20 is opened and a locking position where that opening is closed.

A fuel pipe 36a defining the fuel passage 36 of the circulation system 34 and a gas pipe 60a defining the gas passage 60 are connected to the engaging portion 68. A first connection protrusion 70 which may be brought into engagement with the fuel supply port 22a of the fuel tank 22 and a second connection protrusion 71 which may be brought into engagement with the air inlet 22b of the fuel tank 22 are formed in the engaging portion 68. The first connection protrusion 70 and the second connection protrusion 71 are connected to the fuel pipe 36a and the gas pipe 60a, respectively.

As shown in FIG. 6, to load the fuel tank 22 into the tank receiving slot 20, the fuel tank 22 is inserted into the tank receiving slot through the opening of the tank receiving slot 20 in a state that the cover member 66 of the locking mechanism 64 is moved to the unlocking position, together with the engaging portion 68. Subsequently, as shown in FIG. 7, after the fuel tank 22 is inserted into the tank receiving slot 20 up to the inner part thereof, the cover member 66 is moved to the closing position, the opening of the tank receiving slot is closed, and the fuel tank 22 is made immovable by the cover member 66. As a result, the fuel tank 22 is locked at a predetermined position in the tank receiving slot 20.

As shown in FIGS. 7 and 8, when the cover member 66 is moved to the locking position, the first and second connection protrusions 70 and 71 provided on the engaging portion 68 are fit into the fuel supply port 22a and the air inlet 22b of the fuel tank 22. As a result, the fuel passage 36 of the circulation system 34 is connected to the fuel supply port 22a of the fuel tank 22, and the gas passage 60 is connected to the air inlet 22b of the fuel tank.

As shown in FIG. 8, the fuel supply port 22a and the air inlet 22b of the fuel tank 22, and the first and second connection protrusions 70 and 71 of the engaging portion 68 form the connecting portion. The connecting portion connects the fuel supply port and the air inlet to the circulation system 34 when the fuel tank 22 is locked at the predetermined position. A normally closed valve 72a for opening and closing the fuel supply port 22a is provided in the fuel supply port 22a. A normally closed valve 72b for opening and closing the air inlet 22b is provided in the air inlet 22b. A normally closed valve 74a is provided in the first connection protrusion 70, and opens and closes the passage in the first connection protrusion. A normally closed valve 74b is provided in the second connection protrusion 71, and opens and closes the passage in the second connection protrusion.

In a state that the fuel tank 22 is removed from the tank receiving slot 20, the fuel supply port 22a and the air inlet 22b of the fuel tank are closed with the normally closed valves 72a and 72b, respectively. The passages of the first and second connection protrusions 70 and 71 of the engaging portion 68 are closed with the normally closed valves 74a and 74b, respectively. When the fuel tank 22 is loaded at the predetermined position in the tank receiving slot 20 and the cover member 66 of the locking mechanism 64 is moved to the locking position, the first and second connection protrusions 70 and 71 then are fit into the fuel supply port 22a and the air inlet 22b of the fuel tank 22, respectively, to open the valves 72a, 72b, 74a and 74b. As a result, the fuel passage 36 of the circulation system 34 is connected to the fuel supply port 22a of the fuel tank 22, and the gas passage 60 is connected to the air inlet 22b of the fuel tank.

In the case where the fuel cell apparatus 30 is used as a power source of the portable computer 10 thus constructed, the fuel tank 22 having stored therein methanol is loaded into the tank receiving slot 20 as described above and locked in the coupling position by the locking mechanism 64. In this manner, the fuel tank 22 is coupled to the circulation system 34 of the fuel cell apparatus 30.

In this state, the fuel cell apparatus 30 is driven to generate electricity. In this case, the fuel pump 40 and the air suction pump 48 are operated under the control of the battery controller 50. The fuel pump 40 operates to supply high concentration methanol from the fuel tank 22 to the fuel mixer 42 through the fuel passage 36. The methanol is mixed with water as solvent, which circulates from the cell stack 32, to be diluted to have a predetermined concentration. The methanol aqueous solution diluted in the fuel mixer. 42 is supplied to the anode 47 of the cell stack 32, through the fuel passage 36.

By the air suction pump 48, outside air, i.e., air, is sucked into the air passage from the upstream end of the air passage 38. The air passes through the air intake filter 46 to remove impurities from the air. After passing through the air intake filter 46, the air passes through an air passage 28 and is supplied to the cathode 52 of the cell stack 32.

The methanol aqueous solution and the air, which have reached the cell stack 32, electrochemically react with each other in the polyelectrolyte film 144 located between the anode 47 and the cathode 52 to thereby generate electric power therebetween. The electric power that is generated in the cell stack is supplied to the portable computer 10 under the control of the battery controller 50.

With progress of the electrochemical reaction, the reaction by-products are generated in the cell stack 32; carbon dioxide is generated at the anode 47 and water is generated at the cathode 52. The carbon dioxide generated at the anode 47 and the methanol aqueous solution not having undergone the chemical reaction pass through the fuel passage 36 and are fed to the gas-liquid separator 44. The gas-liquid separator 44 separates the carbon dioxide and the methanol aqueous solution from each other. The methanol aqueous solution is fed from the gas-liquid separator 44 through the fuel passage 36 to the fuel mixer 42 where it is used again for electric power generation. The carbon dioxide is fed to the gas-liquid separator 53 through the gas passage 57, and it passes through the air passage 38 and the exhaust filter 54 and is exhausted to outside.

Most of the water generated at the cathode 52 of the cell stack 32 evaporates into steam, which is discharged into the air passage 38 together with air. The discharged water and steam are fed to the gas-liquid separator 53. Most of the steam is condensed into water by cooling in the gas-liquid separator 53. The generated water and the discharged water pass through the fluid passage 56 and reach the fuel mixer 42 where the water is mixed with methanol and the mixed liquid is fed again to the cell stack 32.

The air fed to the gas-liquid separator 53 and methanol scattered into the air are fed into the exhaust filter 54 which in turn filters off the methanol. The air passes through the exhaust filter 54 and is exhausted to outside from the downstream and of the air passage 38.

During operation of the portable computer 10, fuel is continuously fed from the fuel tank 22 and a volume of the fuel in the tank reduces. A volume of air, which is equal to a volume of the consumed fuel, is taken through the air inlet 22b into the fuel tank 22, and the fuel tank is replenished with the air having such a volume. In this case, the air is taken from the circulation system 34 of the fuel cell apparatus 30. In this instance, the air having passed through the air intake filter 46 and the air suction pump 48 flows from the air passage 38 through the gas passage 60 and is fed into the fuel tank 22.

In the portable computer 10 thus constructed, the air inlet 22b of the fuel tank 22 is connected into the circulation system 34 of the fuel cell apparatus 30. The fuel cell apparatus 30 includes the air intake filter 46 for catching impurities in the air taken in and the exhaust filter 54 for making the by-products in the exhaust air harmless. Therefore, there is no chance that contaminated air enters the circulation system 34. Thus, the air that is taken into the fuel tank 22 from the circulation system 34 is the air circulating in the fuel cell system body or the air cleaned through the air intake filter, thereby preventing the contaminated air and foreign matters from entering the fuel tank 22.

Even if the pressure in the fuel tank 22 becomes high and the fuel reversely flows from the air inlet to spout out, the fuel is fed into the circulation system 34 of the fuel cell apparatus 30 through the gas passage 60, thereby producing no adverse effect on the outside.

It is noted that the air inlet 22b of the fuel tank 22 is connected to a position upstream of the exhaust filter in the air passage of the circulation system 34. With this feature, even when the fuel gas evaporated reversely flows through the air inlet of the fuel tank 22, the fuel gas is made harmless by the exhaust filter and then is exhausted outside. The valve 62 such as a check valve is provided as a reverse flow prevention mechanism in the gas passage 60 connected to the air inlet of the fuel tank 22, thereby preventing the reverse flow of the fuel through the air inlet 22b.

It is also noted that the fuel cell apparatus 30 is provided with the locking mechanism 64 which locks the fuel tank 22 at the predetermined position and closes the opening of the tank receiving slot 20. The fuel supply port and the air inlet of the fuel tank 22 are not opened to be connected to the circulation system 34 until the fuel tank 22 is locked at the predetermined position. This feature prevents one from missing the closing of the cover member 66 and erroneously loading the fuel tank 22, leading to enhancement of the reliability and safety.

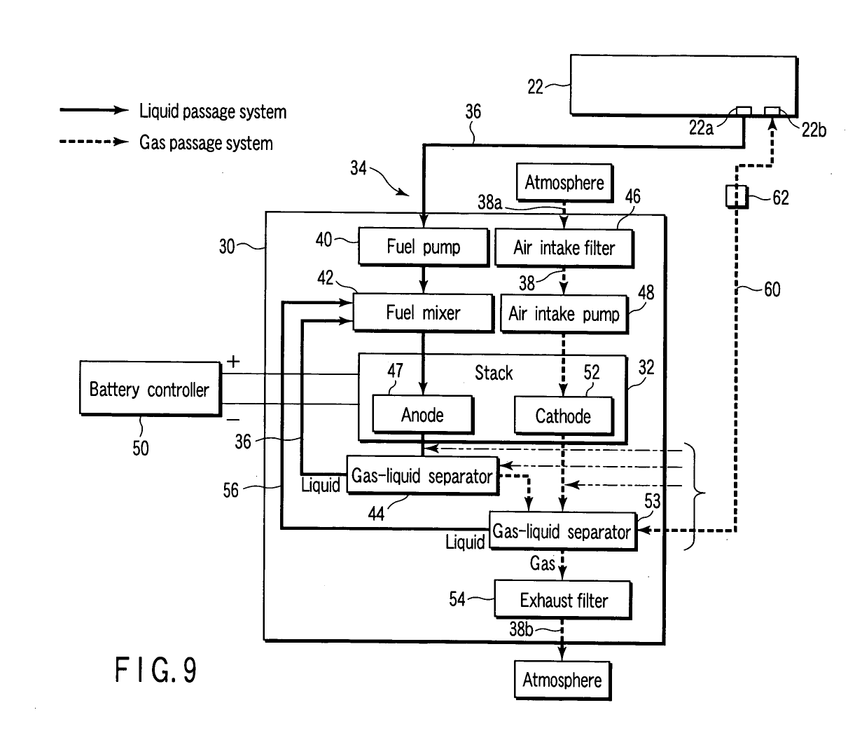

A fuel cell apparatus according to a second embodiment of the present invention will now be described. As shown in FIG. 9, in the second embodiment, the air inlet 22b of the fuel tank 22 is connected to the gas-liquid separator 53 of the circulation system 34 through the gas passage 60 defined by piping. A valve 62, such as a check valve for checking the reverse flow from the air inlet 22b of the fuel tank 22 to the circulation system 34, is installed in the gas passage 60. As indicated by two-dot chain lines in FIG. 9, the air inlet 22b may be connected to an air passage 38 or a fuel passage 36 at a gas-liquid separator 44 or between a downstream side of a cell stack 32 and the gas-liquid separator 44 or 53.

The remaining portion of the second embodiment is substantially the same as the corresponding portion of the first embodiment. Like or equivalent portions are designated by like reference numerals for simplicity.

The second embodiment operates like the first embodiment, and produces useful effects comparable with those by the first embodiment. Even when the fuel tank of which the inner pressure has been increased is loaded and liquid fuel reversely flows from the air inlet, the reversely flowing fuel is returned to or positions near the gas-liquid separator. Thus, the reversely flowing fuel is returned to the fuel passage of the circulation system 34 via the gas-liquid separator, thereby preventing the fuel from leaking out of the fuel cell apparatus.

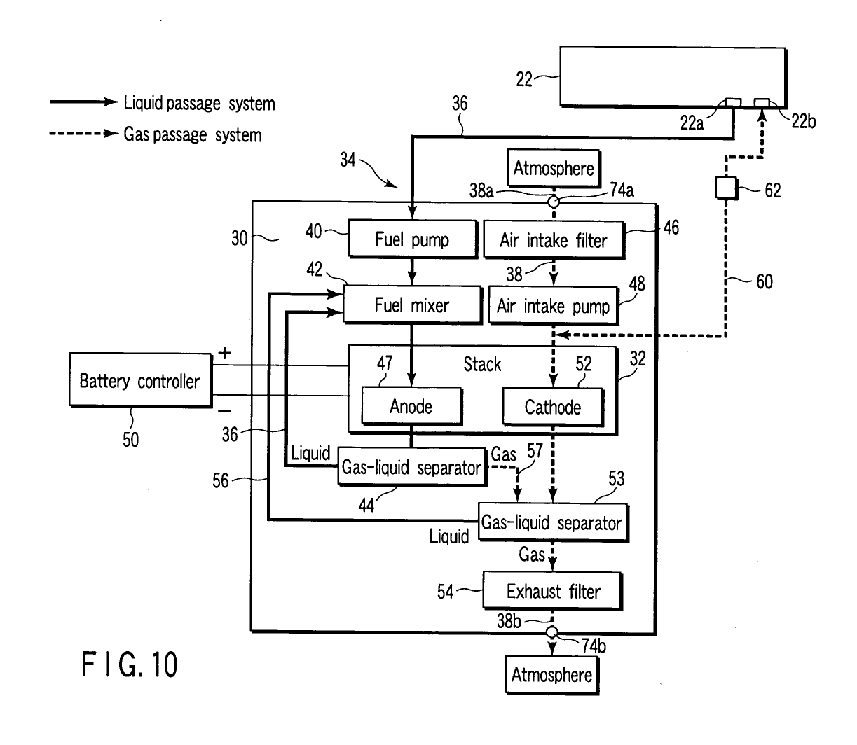

A fuel cell apparatus according to a third embodiment of the present invention will now be described. As shown in FIG. 10, in the third embodiment, a circulation system 34 includes a first on-off valve 74a provided at the upstream end 38a of the air passage 38, which is located upstream of the air intake filter 46, and a second on-off valve 74b provided at the downstream end 38b of the air passage, which is located downstream of the exhaust filter 54. The on-off operations of the first and second on-off valves 74a and 74b are controlled by the battery controller 50. For example, when the portable computer or the fuel cell apparatus 30 is not in operation, the first and second on-off valves 74a and 74b are closed under the control of the battery controller 50 to completely shut off the air passage 38 from the outside.

The remaining portion of the third embodiment is substantially the same as the corresponding portion of the first embodiment. Like or equivalent portions are designated by like reference numerals for simplicity.

The third embodiment operates like the first embodiment, and produces useful effects comparable with those by the first embodiment. The fuel cell apparatus can be shut off from outside air in a state that it is attached with the fuel tank 22 by closing the upstream side of the air intake filter 46 and the downstream side of the exhaust filter 54 respectively by the first and second on-off valves 74a and 74b when the fuel cell apparatus is not in operation.

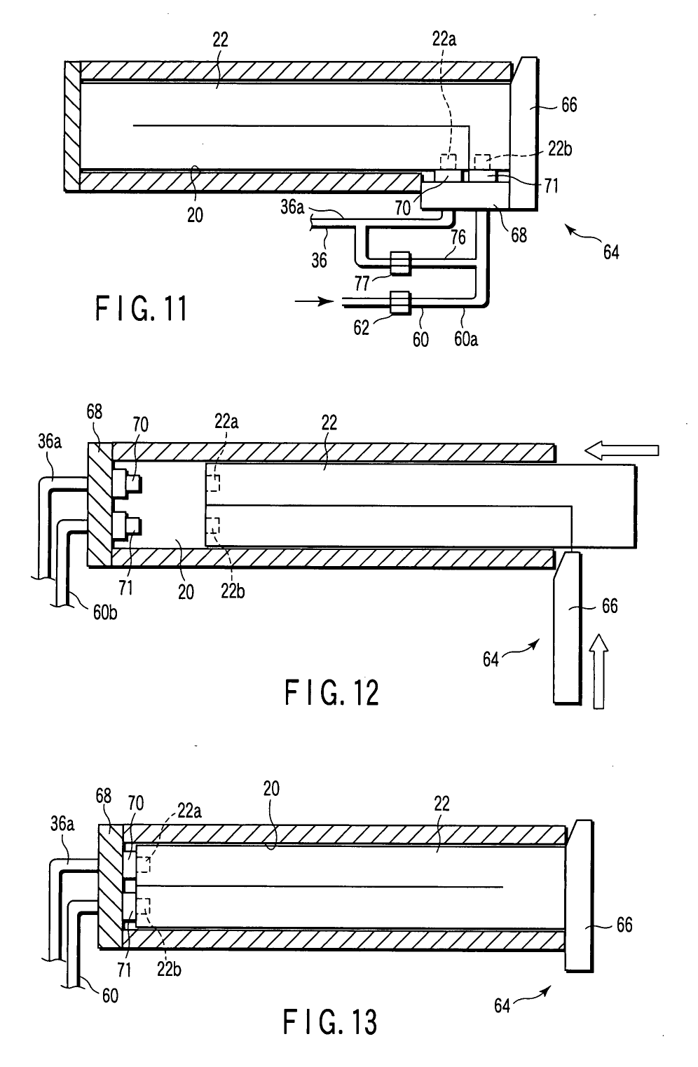

A fourth embodiment of the invention is shown in FIG. 11. In this embodiment, the circulation system 34 includes a gas passage 60, defined by a pipe (first pipe) 60a and coupling the air inlet 22b of the fuel tank 22 and the inside of the circulation system 34 of the fuel cell apparatus 30, and a valve (first valve) 62, installed to the gas passage 60 for checking the reverse flow from the air inlet 22b to the circulation system 34. The circulation system 34 includes a second pipe 76 which is branched from the gas passage 60 at a position between the air inlet 22b and the valve 62 and communicates with the fuel passage 36, and a valve (second valve) 77 which checks the fluid flow from the fuel passage to the air inlet, but allows the fluid flow from the fuel tank 22 to the fuel passage.

When the pressure in the fuel tank 22 becomes high by temperature rise, for example, the fourth embodiment prevents the fuel from reversely flowing from the air inlet 22b to the air passage but also releases the pressure in the fuel tank by directing the reverse fuel flow to the fuel passage. This results in enhancement of reliability and safety.

The remaining portion of the fourth embodiment is substantially the same as the corresponding portion of the first embodiment. Like or equivalent portions are designated by like reference numerals for simplicity. The fourth embodiment operates like the first embodiment, and produces useful effects comparable with those by the first embodiment.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

While the fuel supply port and the air inlet of the fuel tank are provided in the side surface of the fuel tank in the embodiments mentioned above, those may be formed at any other suitable positions. As shown in FIGS. 12 and 13, the fuel supply port 22a and the air inlet 22b may be formed in the end face of the insertion portion of the fuel tank 22. In this case, the engaging portion 68 having the first connection protrusion 70 and the second connection protrusion 71 is formed in the bottom of the tank receiving slot 20. The fuel tank may take any of various shapes, without being limited to the rectangular shape.

While the fuel tank takes the form of a cartridge that is detachably attached to the apparatus in the embodiments mentioned above, it may be fixedly attached to the fuel cell apparatus. In the case of the fuel tank fixedly attached, when fuel is used up, new fuel is supplied to the fuel tank. It is evident that the fuel cell apparatus of the invention may be applied to any suitable electronic devices other than the portable computer. Examples of such electronic devices are mobile devices and portable terminals. Another type of fuel cell such as PEFC (polymer electrolyte fuel cell) may be used in place of the DMFC, as a matter of course.

What is claimed is:

1. A fuel cell apparatus comprising:
a power generator portion which generates electricity through a chemical reaction;
a fuel tank containing fuel and having a fuel supply port which supplies fuel and an air inlet which lets air into the fuel tank; and
a circulation system which supplies fuel and air to the power generator portion, the circulation system having a fuel passage which circulates the fuel supplied from the fuel supply port of the fuel tank through the power generator portion, and an air passage which circulates air through the power generator portion,
wherein the air inlet of the fuel tank is connected to the circulation system.

2. The fuel cell apparatus according to claim 1, wherein the circulation system has an air intake filter provided upstream of the power generator portion in the air passage, and an exhaust filter provided downstream of the power generator portion in the air passage, and the air inlet of the fuel tank is connected to the air passage between the air intake filter and the exhaust filter.

3. The fuel cell apparatus according to claim 1, wherein the circulation system includes a gas-liquid separator which separates gas and fluid from each other, and is provided in at least one of the air passage and the fuel passage at a position downstream of the power generator portion, and the air inlet of the fuel tank is connected to the circulation system at a position between the power generator portion and the gas-liquid separator.

4. The fuel cell apparatus according to claim 1, wherein the circulation system includes a gas-liquid separator which separates gas and fluid from each other, and is provided in at least one of the air passage and the fuel passage at a position downstream of the power generator portion, and the air inlet of the fuel tank is connected to the air-liquid separator.

5. The fuel cell apparatus according to claim 1, further comprising: a pipe which couples the air inlet of the fuel tank and the circulation system; and a valve which checks fluid flow from the air inlet to the circulation system.

6. The fuel cell apparatus according to claim 1, further comprising: a first pipe which couples the air inlet of the fuel tank and the air passage; a second pipe which couples the air inlet of the fuel tank and the fuel passage; a first valve which is provided in the first pipe, and checks the fluid flow from the air inlet to the air passage; and a second valve which is provided in the second pipe, and checks the fluid flow from the fuel passage to the air inlet and allows the fluid flow from the air inlet to the fuel passage.

7. The fuel cell apparatus according to claim 2, wherein the circulation system includes: a first on-off valve located upstream of the air intake filter in the air passage; a second on-off valve located downstream of the exhaust filter in the air passage; and a controller which controls on-off operations of the first and second on-off valves.

8. The fuel cell apparatus according to claim 1, wherein the fuel tank is formed of a fuel cartridge detachably attached to the fuel cell apparatus, and which includes: a locking mechanism which locks the fuel cartridge loaded at a predetermined position at the same predetermined position; and a connecting portion which connects the fuel supply port and the air inlet of the fuel cartridge to the circulation system when the fuel cartridge is locked at the predetermined position.
